(19) United States
(12) Patent Application Publication
(10) Pub. No.: US 2008/0184483 A1
(43) Pub. Date: Aug. 7, 2008

(54) System and Method For Attaching a Drain Assembly to a Plumbing Fixture

(76) Inventor: Robert H. Mayer, Deerfield Beach, FL (US)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 11/913,374

(22) PCT Filed: May 5, 2006
(86) PCT No.: PCT/US06/17251

§ 371 Date: Nov. 1, 2007

Related U.S. Application Data
(63) Continuation of application No. 11/123,493, filed on May 5, 2005.
Application No. 11/123,493 is a continuation-in-part of application No. 11/009,565, filed on Dec. 10, 2004.

(51) Int. Cl. E03C 1/12; B25B 13/48

(52) U.S. Cl. 4/679; 81/52

(57) ABSTRACT

The present invention provides a kit for affixing a drain assembly in a drain port in plumbing fixture. The drain assembly includes a drain ring affixed to a drain pipe. The drain pipe is positionable through the drain port in a bottom surface of the plumbing fixture, such that the drain sink abuts the upper surface of the plumbing fixture. The drain pipe extends through the drain port, past an underside surface of the plumbing fixture surrounding the drain port. A drain nut is rotatably fastened onto the drain pipe. The drain nut includes a first and second of bore therein. A drain nut driver tool is provided, which includes first and second angular extensions for engaging the drain nut. The drain nut driver tool engages the drain nut by removably positioning the first and second angular extensions about the drain pipe into the first and second of bores of the drain nut. The drain nut driver tool is rotated about the drain pipe to secure the drain nut onto the drain pipe.

### TECHNICAL FIELD

The present invention relates generally to plumbing fixture drainage systems, and more particularly to a drain nut, tool, and method for installing the drain nut onto a drain pipe, thereby securing the drain pipe to the plumbing fixture.

### BACKGROUND OF THE INVENTION

Conventionally, drain assemblies are secured to plumbing fixtures such as kitchen, bathroom and utility room lavatories or sinks, by means of a nut disposed on the underside of a sink. The drain nut is threadably engaged on a relatively large diameter, hollow tubular, externally threaded pipe that extends from the drain downwardly through an opening in the bottom of the sink.

The drain assembly typically includes an annular collar which surrounds the drain, resting atop and about the periphery of an opening through the bottom portion of the sink. The drain pipe extends downwardly through the opening past the underside surface of the sink. The drain assembly is secured by engaging the drain nut with the drain pipe and manually advancing the drain nut the full length of the drain pipe, until the drain nut resides in abutment against the undersurface of the sink

The drain nut is initially tightened by hand. However, in order to adequately secure the drain assembly to the sink a tool, such as a basin wrench or a channel lock wrench, is utilized to advance the drain nut to firmly secure the drain nut against the underside of the sink. However, due to the space limitations engaging the drain nut with the tool can be a difficult and time consuming process.

Thus, there exists a need for a system and method for attaching a drain assembly to a plumbing fixture.

### SUMMARY OF THE INVENTION

The present invention provides a drain connection kit for connecting a drain pipe to a plumbing fixture. A drain nut is provided which includes first and second bores and an annular wall with a threading. The annular wall threading is configured and dimensioned to threadably engage the drain pipe exterior threading. A driver tool is provided for engaging the drain nut to rotate the drain nut onto the drain pipe. The driver tool has a first angular extension configured and dimensioned to removably engage the first bore and a second angular extension configured and dimensioned to removably engage the second bore, such that rotation of the driver tool about the drain pipe rotates the drain nut.

The present invention also provides a plumbing fixture, wherein the plumbing fixture can be a sink, lavatory, tub, shower, or any other receptacle or vessel having a drain. The plumbing fixture includes a drain port defining a passage extending through an upper surface to an underside surface of the plumbing fixture. A drain pipe having first and second ends and an exterior threading is included. The drain pipe is positionable through the passage, with the second end of the drain pipe extending past the underside surface of the plumbing fixture. A drain ring is affixed to the first end of the drain pipe, which is positionable about the upper surface of the plumbing fixture, surrounding the drain port. A drain nut is provided which includes first and second bores and an annular wall with a threading. The annular wall threading is configured and dimensioned to threadably engage the drain pipe exterior threading. A driver tool is provided for engaging the drain nut to rotate the drain nut onto the drain pipe. The driver tool has a first angular extension configured and dimensioned to removably engage the first bore and a second angular extension configured and dimensioned to removably engage the second bore such that rotation of the driver tool about the drain pipe rotates the drain nut.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts an exploded view of an embodiment of the drain connector kit of the present invention;

FIG. 2 depicts the drain connector kit of FIG. 1;

FIG. 3 is a perspective view of the drain nut shown in FIG. 1;

FIG. 4 is a top view of a drain nut with several pairs of bores;

FIG. 5 depicts the drain nut driver shown in FIG. 3;

FIG. 6 is a sectional view of the drain connector kit of FIG. 1 installing a drain assembly into a drain port in a bottom portion of a sink;

FIG. 7 depicts another embodiment of a drain nut driver of the present invention;

FIG. 8 is an isometric view of the drain nut driver of FIG. 7 installing a drain nut onto a threaded drain pipe;

FIG. 9 is a top perspective view of another embodiment of a drain nut driver of the present invention;

FIG. 10 is a top view of the drain nut driver of FIG. 9;

FIG. 11 is an exploded view of the drain nut driver of FIG. 9;

FIG. 12 is a bottom perspective view of the drain nut driver of FIG. 9;

FIG. 13 is a top view of the drain nut engaging structure of the drain nut driver of FIG. 9; and

FIG. 14 is a bottom view of the drain nut engaging structure of the drain nut driver of FIG. 9.

### DETAILED DESCRIPTION OF THE INVENTION

The present invention provides a drain connector kit including a drain nut and drain nut driver. The drain nut and drain nut driver are pairingly configured to allow installation of a drain assembly with a driver unit, such as a mechanical or electric driver.

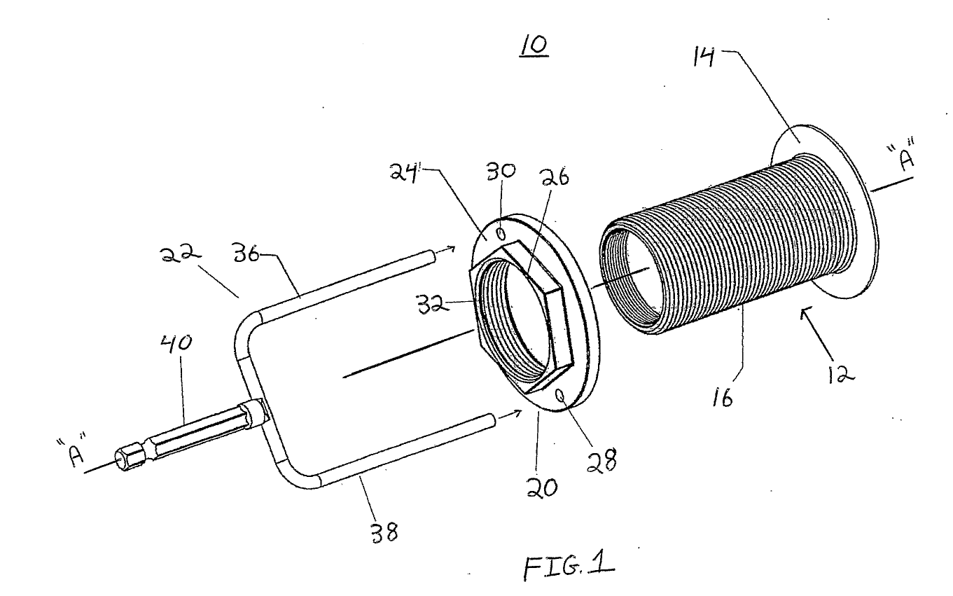

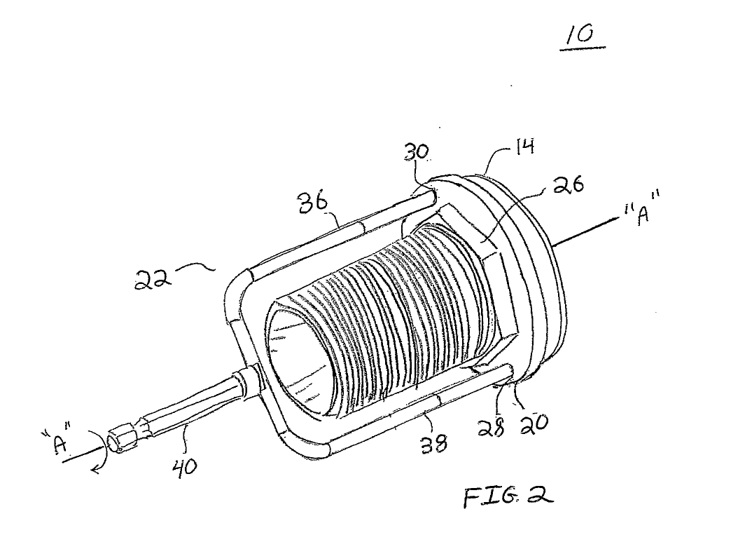

Referring now to the drawings in which like reference designators refer to like elements, there is shown in FIGS. 1 and 2 a drain connector kit 10 of the present invention, including a drain assembly 12. The drain assembly 12 includes a drain ring 14 connected to an externally threaded drain pipe 16. The drain connector kit 10 includes a drain nut 20 to threadably engage the drain pipe 16. A drain nut driver 22 is utilized to drive and thread the drain nut 20 onto the threaded drain pipe 16.

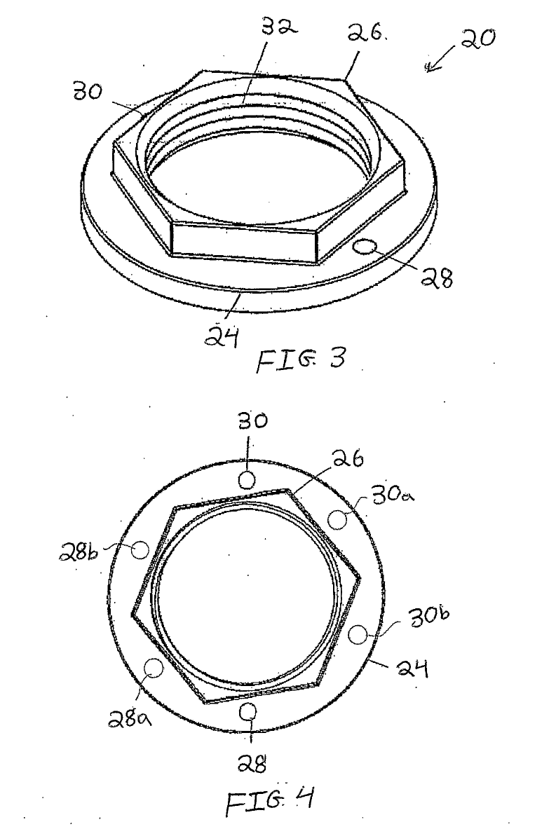

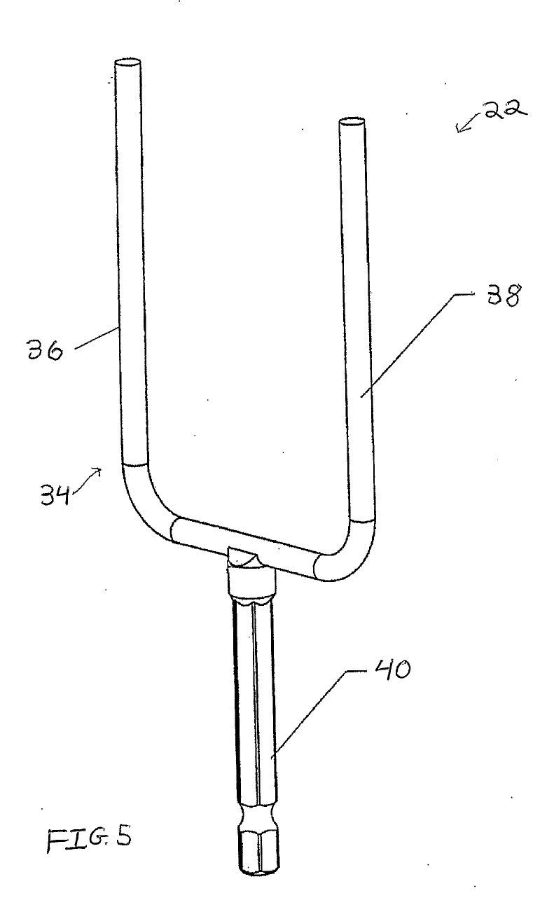

Referring to FIG. 3, the drain nut 20 includes a flange portion 24 and a nut portion 26. The flange portion 24 includes a pair of bores 28 and 30 configured and dimensioned to be engaged by the drain nut driver 22. The drain nut 20 is internally threaded 32 for engagement to the drain pipe 16. As shown in FIG. 4, while the drain nut 20 is shown having a pair of bores 28 and 30, it is contemplated that the drain nut 20 can include any number of bores 28, 30, 28a-b and 30a-b. These bores 28, 30, 28a-b and 30a-b can be opposingly, uniformly, symmetrically, or asymmetrically positioned about the flange portion 24 of the drain nut 20.

Additionally, the bores 28 and 30 are depicted having a circular cross sectional area. However, it is contemplated that the cross sectional area of bores 28 and 30 can have other shapes, including, but not limited to, rectangular, triangular, elliptical, octagonal, hexagonal, diamond, star, etc, and combinations thereof.

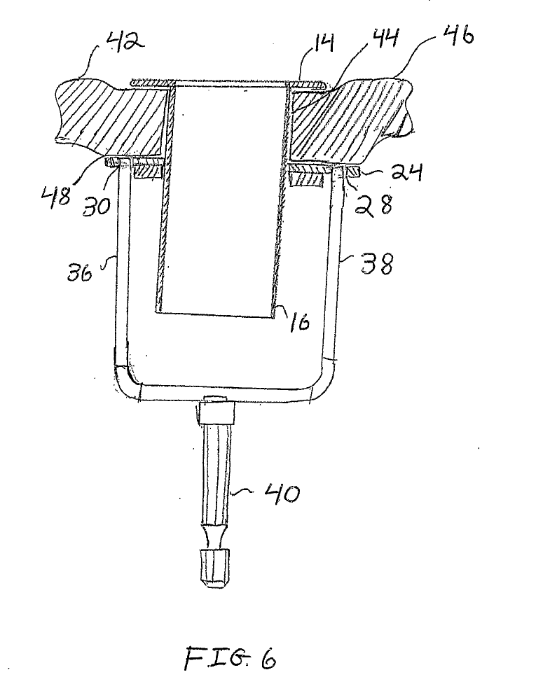

Referring to FIG. 5, the drain nut driver 22 includes a drain nut engaging structure 34. The drain nut engaging structure 34 is substantially U-shaped, having a pair of extensions 36 and 38. The extensions 36 and 38 are provided in a spaced apart relationship for alignment with the pair of bores 28 and 30 in the drain nut 20. The extensions 36 and 38 are shaped, sized, and dimensioned to one each slidingly engage the bores 28 and 30.

The extensions 36 and 38 are depicted having a circular cross sectional area. However, it is contemplated that the cross sectional area of a extensions 36 and 38 can have other shapes, including but not limited to, rectangular, triangular, elliptical, octagonal, hexagonal, diamond, star, etc., matching the cross sectional area of the bores 28 and 30. The present invention contemplates that extensions 36 and 38 can have a shape that is different than the shape of bores 28 and 30. In the instance where the drain nut 20 includes multiple pairs of bores, the extensions 36 and 38 may be selectively positioned in any one of the pairs of bores.

The drain nut engaging structure 34 is affixed to a drive shaft 40. The drive shaft 40 is configured for engagement by a driver unit (not shown), such as a mechanical or electric driver. For example, the drive shaft 40 may have substantially hexagonal cross section area for insertion into and engagement by a chuck of the electric drill. Upon securement of drive shaft 40 in the drill chuck, activation of the electric drill rotates the drain nut engaging structure 34. The electric driver can be used to rotate the drain nut engaging structure 34 in either a clockwise or counter-clockwise direction. While the drain nut engaging structure 34 is shown having an opposing pair of extensions 36 and 38, it is contemplated that the drain nut engaging structure 34 can include any number of extensions, uniformly, symmetrically, or asymmetrically positioned about the drive shaft 40 for engagement with the bores of the drain nut 20.

Referring to FIG. 6, the drain assembly 12 is installed into a plumbing fixture 42. The plumbing fixture 42 can be a sink, lavatory, tub, shower, or any other receptacle or vessel having a drain. The drain pipe 16 is positioned through a drain port 44 in an upper surface 46 of the plumbing fixture 42, such that the drain ring 14 is positioned on the upper surface 46 of the plumbing fixture 42. The drain pipe 16 is of sufficient length such that the drain pipe 16 extends through the drain port 44, beyond an underside surface 48 of the plumbing fixture 42. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 is proximal to the underside surface 48 of the plumbing fixture 42.

The drain nut driver 22 is attached to a driver unit, such as an electric drill, wherein the drive shaft 40 is inserted into and engaged by a drill chuck of the electric drill. Upon securement of drive shaft 40 in the chuck, activation of the electric drill rotates the drain nut driver 22. The electric drill can be used to rotate the drain nut engaging structure 34 in either a clockwise or counter-clockwise direction.

The drain nut driver 22 engages the drain nut 20 by slideably inserting the opposing pair of extensions 36 and 38 of the drain nut engaging structure 34 into the drain nut bores 28 and 30, wherein the drive shaft 40 is substantially aligned along a central longitudinal axis “A” of the drain pipe 16. The electric drill is activated to rotate, thread, the drain nut 20 onto the drain pipe 16. To secure the drain assembly 12 in position, the drain nut 20 is threaded onto the drain pipe 16, wherein the flange portion 24 of the drain nut 20 abuts the underside surface 48 of the plumbing fixture 42. Sufficient torque is applied to the drain nut 20, securing the drain assembly 12 into position.

Similarly, to remove the drain assembly 12, the drain nut driver 22 engages the drain nut 20 by slideably inserting the opposing pair of extensions 36 and 38 of the drain nut engaging structure 34 into the drain nut bores 28 and 30. The electric drill is activated to rotate the drain nut 20 off the drain pipe 16. The drain nut 20 is removed from the drain pipe 16. The drain pipe 16 is then removed from the drain port 44.

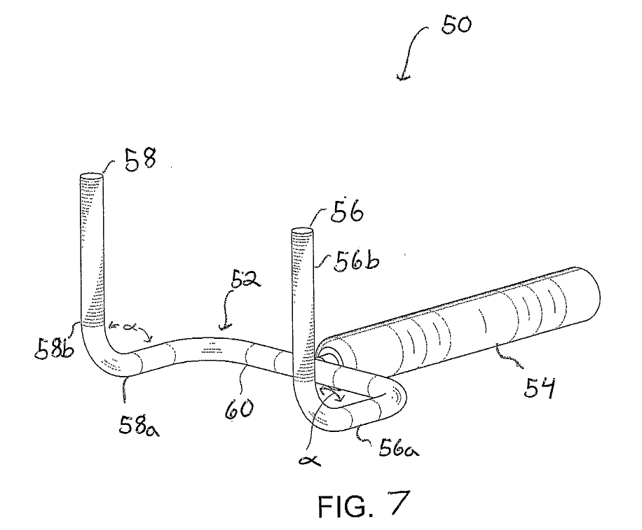

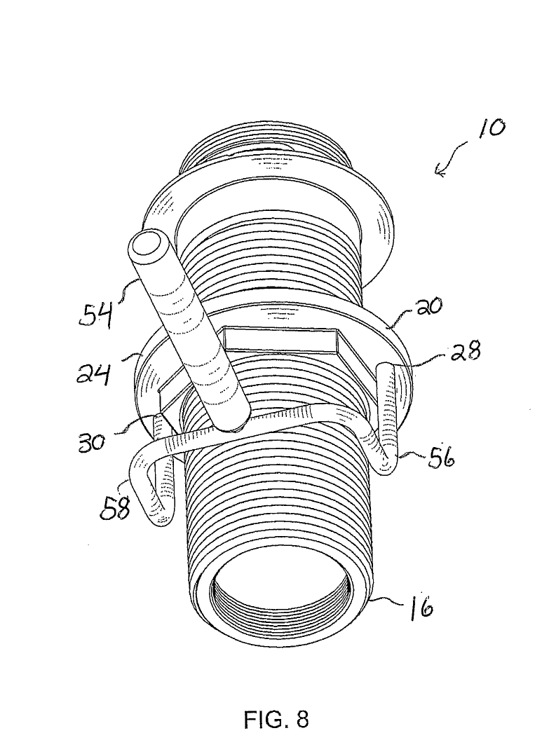

Referring to FIGS. 7 and 8, another embodiment of a drain nut driver 50 includes a drain nut engaging structure 52 affixed to a handle portion 54. The drain nut engaging structure 52 includes a pair of angular extensions 56 and 58. The extensions 56 and 58 each include extending sections 56a and 58a and engaging sections 56b and 58b. The engaging sections 56b and 58b are positioned at an angle “α” with respect to the extending section 56a and 58a. For example, the angular extension 56 and 58 can be substantially L-shaped, having an angle “α” of about 90°. The extensions 56 and 58 are provided in a spaced apart relationship for positioning about the drain pipe 16 and alignment with the pair of bores 28 and 30 in the drain nut 20. The extensions 56 and 58 are shaped, sized, and dimensioned to one each slidingly engage the bores 28 and 30.

The angular extensions 56 and 58 are depicted having a circular cross sectional area. However, it is contemplated that the cross sectional area of a extensions 56 and 58 can have other shapes, including but not limited to, rectangular, triangular, elliptical, octagonal, hexagonal, diamond, star, etc., matching the cross sectional area of the bores 28 and 30. The present invention contemplates that extensions 56 and 58 can have a shape that is different than the shape of bores 28 and 30. In the instance where the drain nut 20 includes multiple pairs of bores, the extensions 56 and 58 may be selectively positioned in any one of the pairs of bores.

As best seen in FIG. 8, a crossbar 60 extends a length sufficient to accommodate the diameter of the drain pipe 16. The extending sections 56a and 58a each have a length such that when each of the engaging sections 56b and 58b are coupled to one of the drain nut bores 28 and 30, the drain nut driver 50 can rotate freely about the drain pipe 16 to selectively tighten or loosen the drain nut 20 regardless of the length of the drain pipe 16. Although the engaging sections 56b and 58b are shown being substantially perpendicular to the extending sections 56a and 58b, (i.e., substantially L-shaped as previous described) any suitable angular relationship could be used.

In use, the drain nut 20 is threaded onto the drain pipe 16 with the drain nut driver 50. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 would be proximal to the underside surface of the plumbing fixture.

The drain nut driver 50 engages the drain nut 20 by positioning the angular extensions 56 and 58 about the drain pipe. The engaging sections 56b and 58b of each of the angular extensions 56 and 58 are slidably inserted into the drain nut bores 28 and 30. The handle portion 54 is rotated around the drain pipe 16, threading the drain nut 20 onto the drain pipe 16. In comparison, the shaft 40 of drain nut driver 22 is rotated along a central longitudinal axis “A” of the drain pipe 16. To secure the drain assembly 10 in position, the drain nut 20 is threaded onto the drain pipe 16, wherein the flange portion 24 of the drain nut 20 abuts an underside surface of the plumbing fixture. Sufficient torque is applied to the drain nut 20, securing the drain assembly 10 into position.

Similarly, to remove the drain assembly 10, the drain nut driver 50 engages the drain nut 20 by positioning the angular extensions 56 and 58 about the drain pipe 16. The engaging sections 56b and 58b of each of the angular extensions 56 and 58 are slidably inserted into the drain nut bores 28 and 30. The handle portion 54 is rotated around the drain pipe 16, rotating the drain nut 20 off the drain pipe 16. The drain nut 20 is removed from the drain pipe 16.

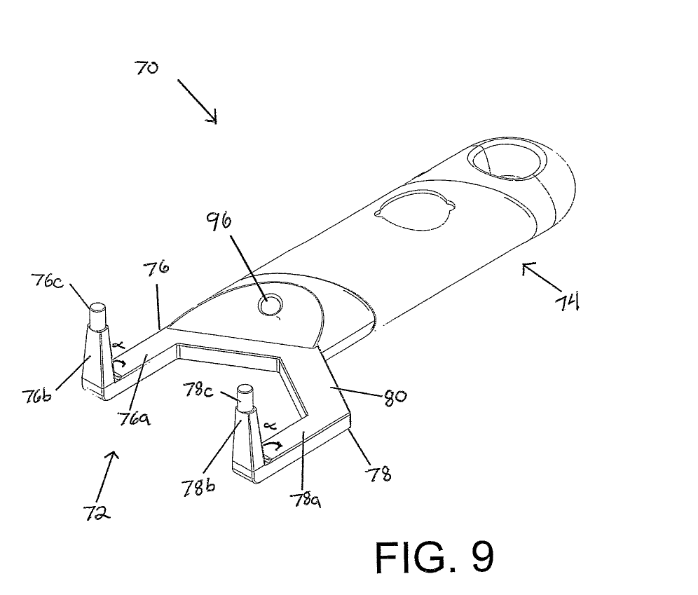

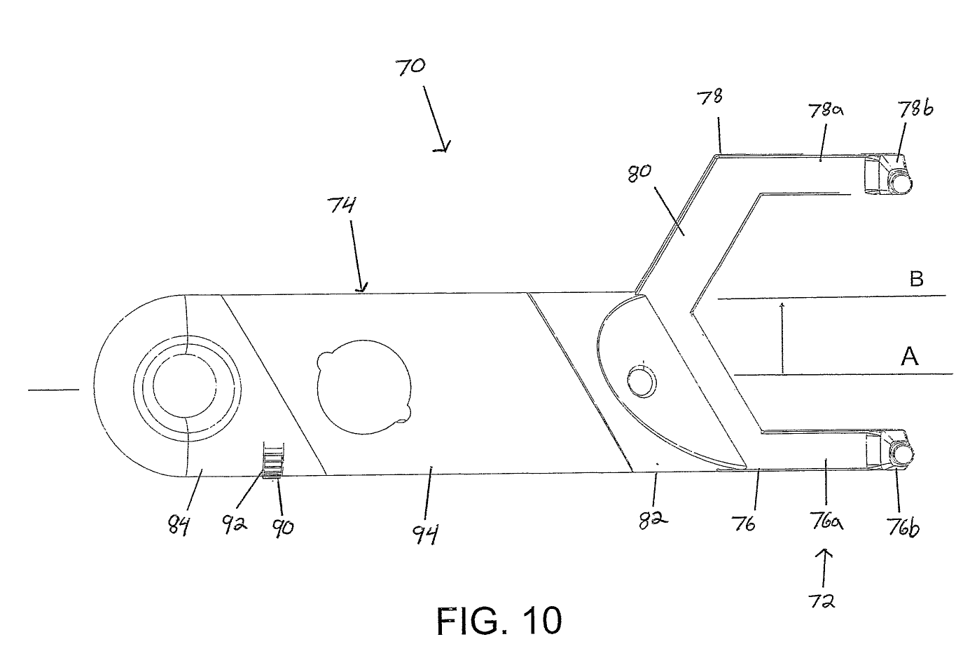

Referring to FIGS. 9 and 10, another embodiment of a drain nut driver 70 includes a drain nut engaging structure 72 affixed to a handle portion 74. The drain nut engaging structure 72 includes a pair of angular extensions 76 and 78. The extensions 76 and 78 each include extending sections 76a and 78a and engaging sections 76b and 78b. The engaging sections 76b and 78b are positioned at an angle “α” with respect to the extending section 76a and 78a. For example, the angular extension 76 and 78 can be substantially L-shaped, having an angle “α” of about 90°.

The extensions 76 and 78 are provided in a spaced apart relationship for positioning about the drain pipe 16 and alignment with the pair of bores 28 and 30 in the drain nut 20. The extensions 76 and 78 are provided in an offset relation to a central longitudinal axis “A” of the handle portion 74, such that a central axis “B” of the extensions 76 and 78 is offset from the central axis longitudinal axis “A” of the handle portion 74. To provide the extension offset a lever arm 80 is provided in extension 78. The extension offset provides leverage to a user of the drain nut driver 70 to aid in the tightening or removal of the drain nut 20. The tips 76c and 78c of the extensions 76 and 78 are shaped, sized, and dimensioned to one each slidingly engage the bores 28 and 30.

The tips 76c and 78c of the extensions 76 and 78 are depicted having a circular cross sectional area. However, it is contemplated that the cross sectional area of tips 76c and 78c of the extensions 76 and 78 can have other shapes, including but not limited to, rectangular, triangular, elliptical, octagonal, hexagonal, diamond, star, etc., matching the cross sectional area of the bores 28 and 30. The present invention contemplates that extensions 76 and 78 can have a shape that is different than the shape of bores 28 and 30. In the instance where the drain nut 20 includes multiple pairs of bores, the extensions 76 and 78 may be selectively positioned in any one of the pairs of bores.

As best seen in FIG. 10, the lever arm 80 extends a length sufficient to accommodate the diameter of the drain pipe 16. The extending sections 76a and 78a each have a length such that when each of the engaging sections 76b and 78b are coupled to one of the drain nut bores 28 and 30, the drain nut driver 70 can rotate freely about the drain pipe 16 to selectively tighten or loosen the drain nut 20 regardless of the length of the drain pipe 16. Although the engaging sections 76b and 78b are shown being substantially perpendicular to the extending sections 76a and 78b, (i.e., substantially L-shaped as previous described) any suitable angular relationship could be used.

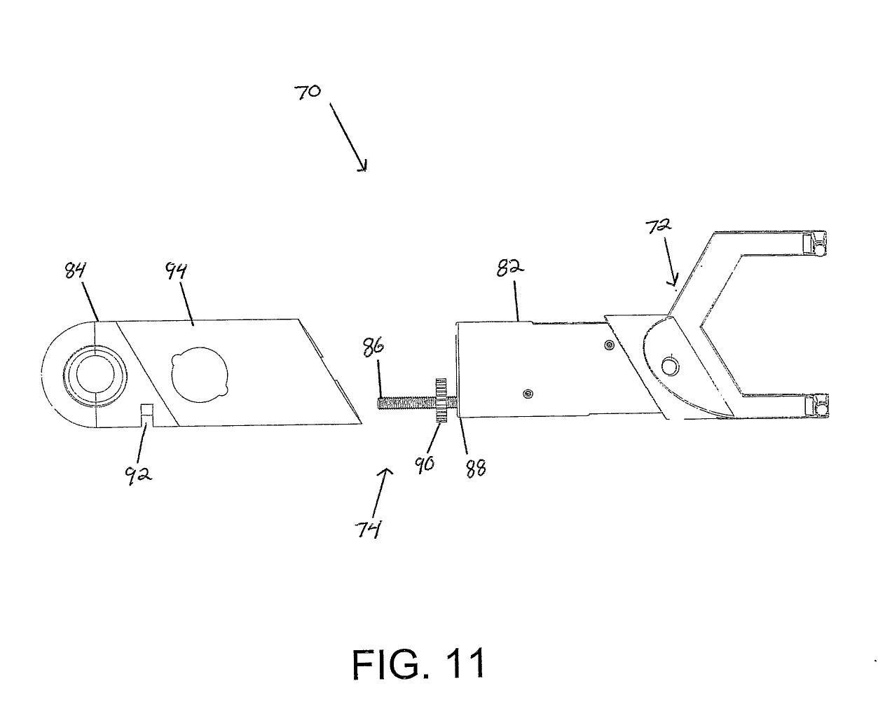

Referring to FIGS. 10 and 11, the length of the handle portion 74 is adjustable. The handle portion 74 includes an inner handle portion 82, affixed to the drain nut engaging structure 72, and a hollow outer handle portion 84 slidingly positioned onto the inner handle portion 84. A threaded member 86 is affixed to an end 88 of the inner handle portion 82, where an adjustment control member 90 can be threadably positioned on the threaded member 86. When assembled, the outer handle portion 84 is slidingly positioned on the inner handle portion 82, where the adjustment control member 90 is rotatably positioned in a slotted section 92 of the outer handle portion 84 and threaded onto the threaded member 86. A rotation of the adjustment control member 90 on the threaded member 86, moves the adjustment control member 90 along the threaded member 86 such that the outer handle portion 84 is moved along the inner handle portion 82. In this manner, the length of the handle portion 74 can be adjusted.

The outer handle portion 84 can further include a gripping element 94 positioned about the outer handle portion 84. The gripping element 94 can include a textured surface or coating about the outer handle portion 84, such that a user can more securely grip the drain nut driver 70, decreasing the likelihood of slipping.

Alternatively, the gripping element 94 can include an outer sleeve positioned about the outer handle portion 84. The outer sleeve can be made of a flexible material, which can be securely positioned about the outer handle portion 84, such that such that a user can more securely grip the drain nut driver 70, decreasing the likelihood of slipping. The outer sleeve can further include a textured surface, which can further decrease the likelihood of slipping.

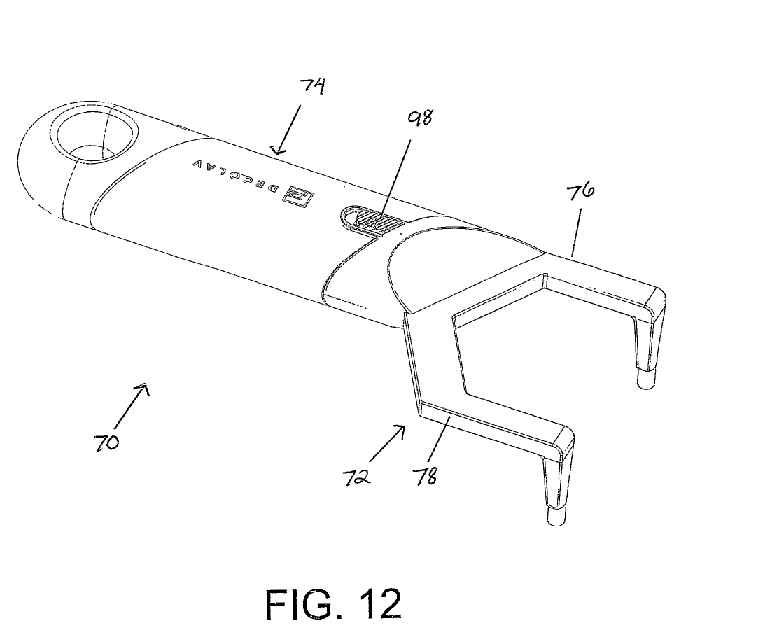

Referring to FIGS. 9 and 12, the drain nut driver 70 can include a light element 96 positioned adjacent to the extensions 76 and 78. The light element can be turn on and off by a switch 98 positioned in the handle portion 74. The light element 98 can be used to illuminate the drain nut 20, thereby facilitating the drain nut driver 70 engagement of the drain nut 20.

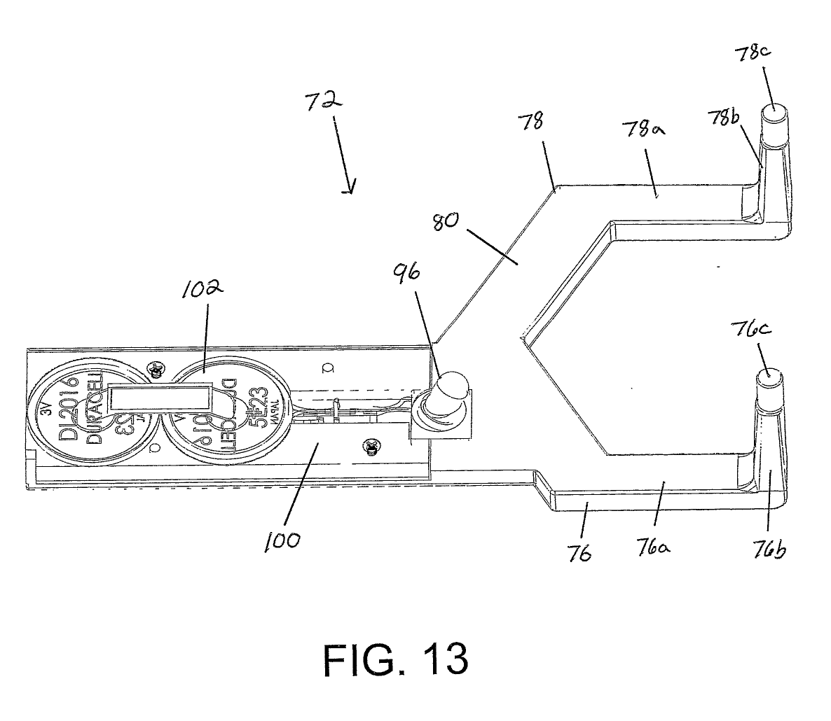

Referring to FIG. 13, the drain nut engaging structure 72 is formed of a unitary construction having an elongated portion 100 extending into the extensions 76 and 78. As previously discussed, the extensions 76 and 78 each include extending sections 76a and 78a and engaging sections 76b and 78b. The engaging sections 76b and 78b are positioned at an angle “α” with respect to the extending section 76a and 78a. For example, the angular extension 76 and 78 can be substantially L-shaped, having an angle “α” of about 90°.

The extensions 76 and 78 are provided in a spaced apart relationship for positioning about the drain pipe 16 and alignment with the pair of bores 28 and 30 in the drain nut 20. The extensions 76 and 78 are provided in an offset relation to a central longitudinal axis “A” of the of the elongated portion 100, where the central longitudinal axis “A” of the elongated portion 100 is the same as that for the handle portion 74, such that a central axis “B” of the extensions 76 and 78 is offset from the central axis longitudinal axis “A” of the handle portion 74.

The nut engaging structure 72 is made of a material of sufficient strength to allow for the installation and removal of the drain nut. For example, the nut engaging structure 72 can be made of a metal, hard plastic, composite material, and the like.

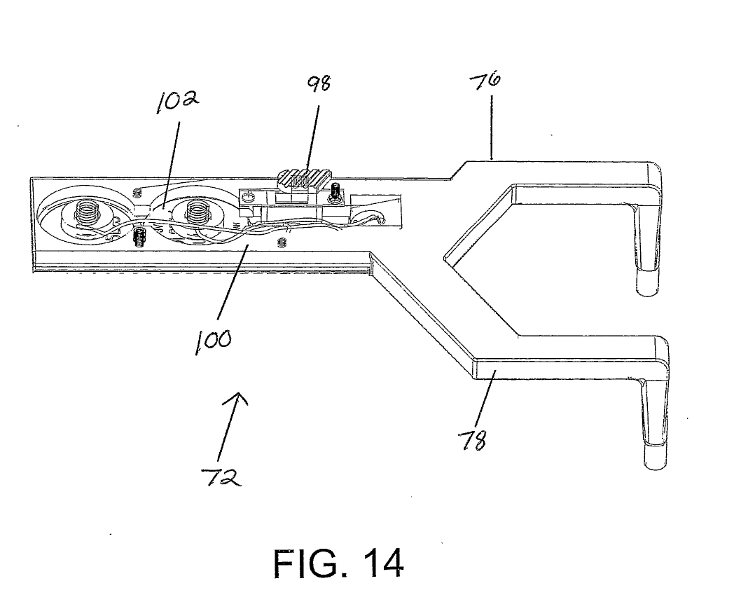

Referring to FIGS. 13 and 14, the light element is positioned on the elongated portion 100 of the drain nut engaging structure 72, proximal to the extensions 76 and 78, where at least a portion of the light element extends thought the handle portion 74. Similarly, the switch 98 is positioned on the elongated portion 100 of the drain nut engaging structure 72, where the switch 98 can be positioned on the opposite side or the same side on the elongated portion 100 of the drain nut engaging structure 72. A power supply 102, is position on/in the elongated portion 100 of the drain nut engaging structure 72 and operably connected to the switch 98 and the light element, such that an actuation of the switch 98 can optionally turn the light element on and off. The power supply 102 can take the form of at least one battery, where the battery is of sufficient size to fit within the handle portion 74.

In use, the drain nut 20 is threaded onto the drain pipe 16 with the drain nut driver 70. The drain nut 20 is threaded onto the drain pipe 16, wherein the internal threads 32 of the drain nut 20 engage the threaded drain pipe 16. The drain nut 20 is positioned on the drain pipe 16, such that the flange portion 24 of the drain nut 20 would be proximal to the underside surface of the plumbing fixture.

The drain nut driver 70 engages the drain nut 20 by positioning the angular extensions 76 and 78 about the drain pipe. The engaging sections 76b and 78b of each of the angular extensions 76 and 78 are slidably inserted into the drain nut bores 28 and 30. The light element 98 can be turned on to aid in the placement of the engaging sections 76b and 78b into the drain nut bores 28 and 30.

The handle portion 74 is rotated around the drain pipe 16, threading the drain nut 20 onto the drain pipe 16. To secure the drain assembly in position, the drain nut 20 is threaded onto the drain pipe 16, wherein the flange portion 24 of the drain nut 20 abuts an underside surface of the plumbing fixture. Sufficient torque is applied to the drain nut 20, securing the drain assembly 10 into position.

Similarly, to remove the drain assembly 10, the drain nut driver 70 engages the drain nut 20 by positioning the angular extensions 76 and 78 about the drain pipe 16. The engaging sections 76b and 78b of each of the angular extensions 76 and 78 are slidably inserted into the drain nut bores 28 and 30. The handle portion 74 is rotated around the drain pipe 16, rotating the drain nut 20 off the drain pipe 16. The drain nut 20 is removed from the drain pipe 16.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A driver tool for threading a drain nut about a threaded drain pipe, comprising:
a handle portion; and
a pair of angular extensions affixed to the handle portion in a spaced apart relationship to be fitted about the drain pipe, each of the angular extensions including an extending section, proximal to the handle portion, and an engaging section extending from the extending section, wherein the engaging section extends at an angle with respect to the extending section.

2. The driver tool of claim 1, wherein the engaging section extends at an angle of about 90 degrees with respect to the extending section.

3. The driver tool of claims 1, wherein the handle portion includes a central longitudinal axis and the pair of angular extensions include a central axis, and the pair of angular extensions are affixed to the handle portion such that the central axis of the angular extensions is offset from the central longitudinal axis of the handle portion.

4. The driver tool of claim 1, wherein the handle portion has an adjustable length.

5. The driver tool of claim 4, wherein the handle portion comprises:
an inner handle portion affixed to the pair of angular extensions; and
an outer handle portion slidingly positionable about the inner handle portion.

6. The driver tool of claim 5, the handle portion further comprising an adjustment controller, the adjustment controller controlling the position of the outer handle portion with respect to the inner handle portion.

7. The driver tool of claim 1, further comprising;
a light positioned in the handle portion, proximal to the pair of angular extensions,
a switch positioned in the handle portion; and
a power supply operably connected to the light and the switch.

8. The driver tool of claim 1, wherein the angular extensions each have a circular cross sectional area.

9. The driver tool of claim 1, wherein the angular extensions each have a cross sectional area selected from the group consisting of circular, rectangular, triangular, elliptical, octagonal, hexagonal, and diamond shaped.

10. A drain connection kit for connecting a drain pipe having an exterior threading to a plumbing fixture, comprising:
a drain nut having a first pair of bores, including first and second bores, and an annular wall with a threading, the annular wall threading configured and dimensioned to threadably engage the drain pipe exterior threading; and
a driver tool having a first angular extension configured and dimensioned to removably engage the first bore and a second angular extension configured and dimensioned to removably engage the second bore such that rotation of the driver tool about the drain pipe rotates the drain nut, wherein the first and second angular extensions are provided in a spaced apart relationship to be fitted about the drain pipe.

11. The drain connection kit of claim 10, the drain nut comprising a flange portion, wherein the first pair of bores are disposed about the flange portion.

12. The drain connection kit of claim 11, further comprising a second pair of bores, wherein each of the bores are opposingly positioned about the flange portion.

13. The drain connection kit of claim 11, further comprising a second pair of bores, wherein each of the bores are opposingly and uniformly positioned about the flange portion.

14. The drain connection kit of claim 11, further comprising a second pair of bores, wherein each of the bores are uniformly and symmetrically positioned about the flange portion.

15. The drain connection kit of claim 11, further comprising a second pair of bores, wherein each of the bores are asymmetrically positioned about the flange portion.

16. The drain connection kit of claim 10, the driver tool comprising a handle portion affixed to the first and second angular extensions.

17. The drain connection kit of claim 10, wherein the drain pipe includes a drain ring affixed to a first end of the drain pipe.

18. The drain connection kit of claim 17, wherein the drain pipe is positionable through a drain port in the plumbing fixture, such that the drain ring is positioned about an upper surface surrounding the drain port and the drain pipe extends past an underside surface surrounding the drain port.

19. A plumbing fixture, comprising:
a drain port defining a passage extending though an upper surface to an underside surface of the plumbing fixture;
a drain pipe having first and second ends and an exterior threading, wherein the drain pipe is positionable through the passage, such that the second end of the drain pipe extends past the underside surface of the plumbing fixture;
a drain ring affixed to the first end of the drain pipe and positionable about the upper surface of the plumbing fixture, surrounding the drain port;
a drain nut having a first pair of bores, including first and second bores, and an annular wall with a threading, the annular wall threading configured and dimensioned to threadably engage the drain pipe exterior threading; and
a driver tool having a first angular extension configured and dimensioned to removably engage the first bore and a second angular extension configured and dimensioned to removably engage the second bore such that rotation of the driver tool about the drain pipe rotates the drain nut, wherein the first and second angular extensions are provided in a spaced apart relationship to be fitted about the drain pipe.

20. The plumbing fixture of claim 19, the drain nut comprising a flange portion, wherein the first and second bores are disposed about the flange portion.

21. The plumbing fixture of claim 20, further comprising a second pair of bores positioned about the flange portion.

22. The plumbing fixture of claim 20, the driver tool comprising a handle portion affixed to the first and second angular extensions.

23. The plumbing fixture of claim 19, wherein the plumbing fixture is a sink.
